(19) United States
(12) Patent Application Publication
(10) Pub. No.: US 2002/0071661 A1
(43) Pub. Date: Jun. 13, 2002

(54) Audio and video reproduction apparatus

(76) Inventors: Kenji Nakano, Kanagawa (JP); Akira Sakamoto, Tokyo (JP); Hiroki Matsuyama, Chiba (JP)

Correspondence Address: COOPER & DUNHAM LLP, 1185 Avenue of the Americas, New York, NY, 10036, US

(21) Appl. No.: 09/994,140

(22) Filed: Nov. 26, 2001

(30) Foreign Application Priority Data
Nov. 30, 2000 (JP) P2000-364073

(51) Int. Cl. H04N 5/92; H04N 7/52

(52) U.S. Cl. 386/96; 386/106

(57) ABSTRACT

Disclosed is an audio and video reproduction apparatus including a head mounted display for converting a received video signal into an image to be presented to a listener/watcher; a pair of acoustic transducers each used for converting an audio signal into a sound to present to the listener/watcher; detection means for detecting an orientation of the head of the listener/watcher; image-changing means for changing the video signal supplied to the head mounted display in accordance with an orientation of the head of the listener/watcher; and sound-image localization processing means for changing an sound-image localized position of an audio signal reproduced by the acoustic transducers, in accordance with an orientation of the head of the listener/watcher.

### BACKGROUND OF THE INVENTION

The present invention relates to a reproduction apparatus and, more particularly, relates to an audio and video reproduction apparatus for reproducing audio and video signals.

In recent years, in the field of image processing, there has been becoming popular an apparatus for generating an image surrounding a listener/watcher over a range of 360 degrees, that is, in all directions. Such an image is referred to hereinafter as a wide-angle image having a variety of types ranging from the type of an artificially created image such as a CG (Computer Graphics) to the type of an image obtained as a result of seamless combination of image portions, which are taken simultaneously by using a plurality of video cameras from objects of photographing. The types are different from each other due to different approach methods.

In addition, a sound accompanying a wide-angle image also surrounds the listener/watcher over the range of 360 degrees. Such a sound is referred to hereinafter as a wide-angle sound, which can be obtained as a result of artificial combination of sound materials or a result of a recording operation carried out by using a multi-channel stereo system at the same time as a photographing operation of a wide-angle image.

FIG. 3 is a diagram showing a typical recording apparatus capable of implementing live photographing. As shown in the figure, this typical recording apparatus includes 3 video cameras 21A to 21C and 6 microphones 22A to 22F.

In the horizontal directions, the video cameras 21A to 21C have a photographing range of at least 120 degrees. The video cameras 21A to 21C are fixed on a base 23 in such a way that the optical axes of projection lenses of the cameras 21A to 21C lie on the same horizontal plane and are separated from each other by an angular gap of 120 degrees. Thus, the video cameras 21A to 21C are capable of photographing an image stretched over a 360-degree range surrounding the base 23 without missing any portions of the image.

In addition, the microphones 22A to 22F each have a uni-directional characteristic. The microphones 22A to 22F are also fixed on the base 23 in such a way that directivity axes (or main axes) of the microphones 22A to 22F also lie on the horizontal plane including the optical axes of the projection lenses of the video cameras 21A to 21C and are separated from each other by an angular gap of 60 degrees. In addition, the main axes of the microphones 22A and 22B are each separated from the optical axis of the projection lens of the video camera 21A by an angular gap of 30 degrees. By the same token, the main axes of the microphones 22C and 22D are each separated from the optical axis of the projection lens of the video camera 21B by an angular gap of 30 degrees. In the same way, the main axes of the microphones 22E and 22F are each separated from the optical axis of the projection lens of the video camera 21C by an angular gap of 30 degrees. Thus, the microphones 21A to 21F are capable of picking up a sound stretched over a 360-degree range surrounding the base 23 without missing any portions of the sound.

A video signal obtained from the video camera 21A and audio signals (or sound signals) obtained from the microphones 22A and 22B are supplied to a digital VTR (Video Tape Recorder) 24A to be recorded as digital data.

In the same way, a video signal obtained from the video camera 21B and audio signals obtained from the microphones 22C and 22D are supplied to a digital VTR 24B to be recorded as digital data. By the same token, a video signal obtained from the video camera 21C and audio signals obtained from the microphones 22E and 22F are supplied to a digital VTR 24C to be recorded as digital data. It should be noted that, in a recording operation, the VTRs 24A to 24C are operated synchronously with each other.

Then, the video and audio signals recorded in the VTRs 24A to 24C are edited and recorded as digital signals onto predetermined media such as a DVD (Digital Versatile Disc) 25. It should be noted that, at that time, the video signals obtained as results of photographing using the video cameras 21A to 21C are subjected to correction processing so that images represented by the video signals can be combined with each other to create a seamless image.

On the other hand, FIG. 4 is a diagram showing a typical reproduction apparatus for reproducing video and audio signals from the DVD 25, on which the video and audio signals were recorded by using the recording apparatus described above.

As shown in the figure, the listener/watcher 30 has a seat at the center of a dome-type or a ring-type screen 31. That is to say, the screen 31 is provided over a 360-degree range surrounding the listener/watcher 30. On a front 120-degree range arc 31A in front of the listener/watcher 30, an image taken by the video camera 21A is projected. By the same token, on a right-rear 120-degree range arc 31B on the right side behind the listener/watcher 30, an image taken by the video camera 21B is projected. In the same way, on a left-rear 120-degree range arc 31C on the left side behind the listener/watcher 30, an image taken by the video camera 21C is projected. In addition, 6 speakers 32A to 32F are provided on the outer side of the screen 31 at equal angular intervals of about 60 degrees, surrounding the screen 31. The speakers 32A to 32F receive audio signals picked up by the microphones 22A to 22F respectively.

Thus, a wide-angle image photographed by the recording apparatus shown in FIG. 3 is displayed on the screen 31 and, at the same time, a wide-angle sound picked up by the apparatus shown in FIG. 3 is reproduced in a surrounding manner.

However, while the dome-type or ring-type screen 31 and the speakers 32A to 32F surrounding the screen 31 as shown in FIG. 4 can be provided in a large facility or the like, it is difficult to install them in an ordinary home. It is thus impossible to enjoy a wide-angle image and a wide-angle sound with ease.

In order to solve the problem, reproduction of an image by using an HMD (Head Mounted Display) and reproduction of a sound by using headphones are conceived to make it possible to enjoy a wide-angle image and a wide-angle sound with ease.

In this case, however, there is raised a problem as to which portion of a wide-angle image is to be reproduced by using an HMD. Furthermore, the reproduction of a sound by using headphones also has a problem that a sound image is localized inside the head of the listener/watcher 30 in spite of the fact that the sound image will be localized, for example, in front of the listener/watcher 30 should the sound be generated by a front speaker. In addition, in the case of the reproduction apparatus shown in FIG. 4, a sound image will be localized at its original position as it is even if the orientation of the head of the listener/watcher 30 is changed. In the case of headphones reproduction, on the other hand, a sound image localized outside the head of the listener/watcher 30 will be moved along with the orientation of the head when the orientation is changed.

### SUMMARY OF THE INVENTION

The present invention solves the problems described above.

In order to solve the problems described above, in accordance with an aspect of the present invention, there is provided an audio and video reproduction apparatus including: a head mounted display for converting a received video signal into an image to be presented to a listener/watcher; a pair of acoustic transducers each used for converting an audio signal into a sound to be presented to the listener/watcher; detection means for detecting an orientation of the head of the listener/watcher; image-changing means for changing the video signal supplied to the head mounted display in accordance with an orientation of the head of the listener/watcher; and sound-image localization processing means for changing an sound-image localized position of an audio signal reproduced by the acoustic transducers, in accordance with an orientation of the head of the listener/watcher.

The above and other objects, features and advantages of the present invention as well as the manner of realizing them will become more apparent whereas the invention itself will best be understood from a careful study of the following description and appended claims with reference to attached drawings showing a preferred embodiment of the invention.

### BRIEF DESCRIPTION OF THE DRAWINGS

FIG. 1 is a diagram showing a typical reproduction apparatus as implemented by an embodiment of the present invention;

FIG. 2 is a top-view explanatory diagram used for describing the present invention;

FIG. 3 is a top-view explanatory diagram used for describing the present invention; and

FIG. 4 is a top-view explanatory diagram used for describing the present invention.

### DETAILED DESCRIPTION OF THE PREFERRED EMBODIMENT

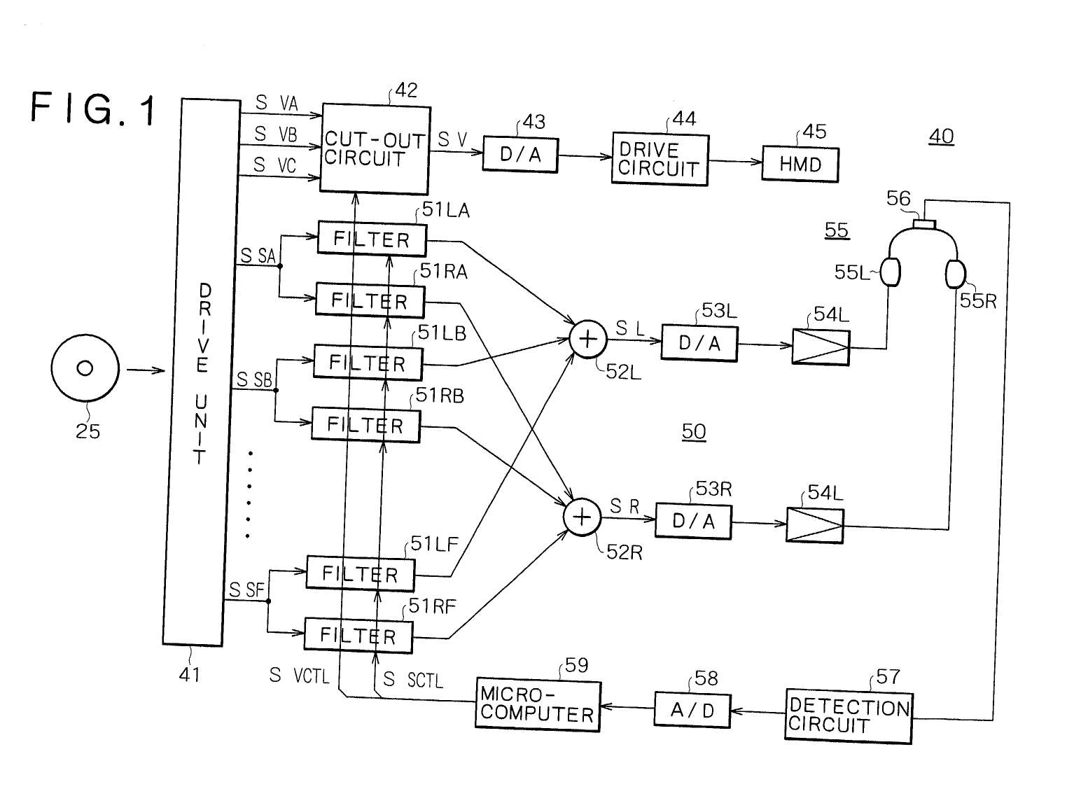

FIG. 1 is a diagram showing a typical reproduction apparatus for reproducing a wide-angle image and a wide-angle sound in accordance with the present invention. In the figure, reference numeral 40 denotes the reproduction apparatus. In the reproduction apparatus 40, a video signal representing a wide-angle image and an audio signal representing a wide-angle sound are reproduced by a drive unit 41 from a DVD 25.

The video and audio signals output by the drive unit 41 are typically signals recorded by the recording apparatus shown in FIG. 3. To be more specific, the video signal output by the drive unit 41 is video signals SVA to SVC generated by the video cameras 21A to 21C respectively, and the audio signal output by the drive unit 41 is audio signals SSA to SSF generated by the microphones 22A to 22F respectively. It should be noted that the video signals SVA to SVC and the audio signals SSA to SSF are each a digital signal. The video signals SVA to SVC are subjected to correction processing so that images represented by the video signals SVA to SVC can be combined with each other to form a seamless image.

The video signals SVA to SVC are supplied to a cutout circuit 42 for extracting a video signal SV representing an image in a particular field of vision from wide-angle images photographed by the video cameras 21A to 21C. The particular field of vision is a field of vision that can be seen by the listener/watcher 30 without moving the head. The digital video signal SV is supplied to a D/A (Digital to Analog) conversion circuit 43 for converting the digital video signal into an analog video signal in D/A conversion. The analog video signal is supplied to an HMD 45 by way of a drive circuit 44.

Thus, when the listener/watcher 30 mounts the HMD 45 on his/her head, the listener/watcher 30 is capable of watching an image in a vision-field range extracted by the cut-out circuit 42 from the wide-angle images photographed by the 21A to 21C by using the HMD 45.

In addition, audio signals SSA to SSF output by the drive unit 41 are supplied to headphones (or a pair of earphones) as reproduction signals. In order to prevent a sound image reproduced by the headphones from being localized inside the head of the listener/watcher 30, a sound-field-transforming circuit 50 is provided.

In the case of headphones reproduction, a sound image is localized inside the head of the listener/watcher 30 because audio transfer functions between the headphones and the ears of the listener/watcher 30 is different from audio transfer functions between the speakers and the ears of the listener/watcher 30.

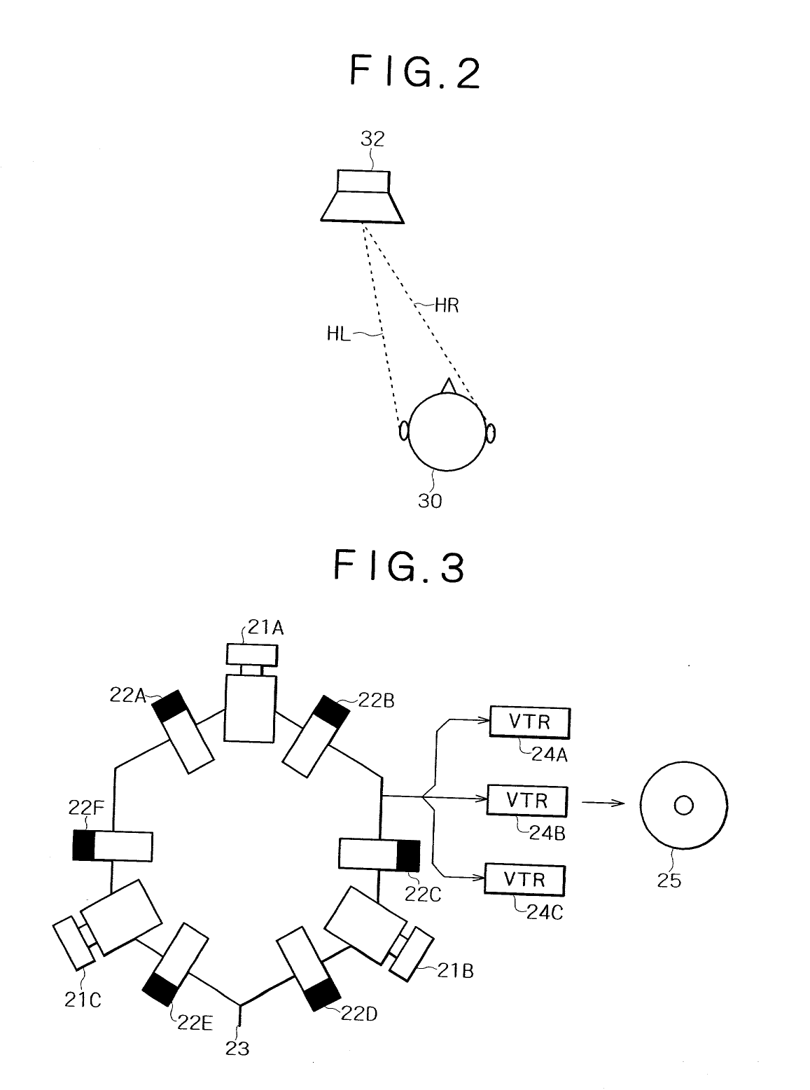

Assume that a sound source 32 is placed in front of the listener/watcher 30 as shown in FIG. 2 and let: notation HL denote a head related transfer function from the sound source 32 to the left ear of the listener/watcher 30 while notation HR denote a head related transfer function from the sound source 32 to the right ear of the listener/watcher 30.

In this case, since the headphones are put at the positions of both the ears of the listener/watcher 30 in headphones reproduction, the head related transfer functions HL and HR are applied to an audio signal supplied to the headphones.

The sound-field-transforming circuit 50 is typically configured as follows. Audio signals SSA to SSF from the drive unit 41 are supplied to an addition circuit 52L by way of FIR (Finite Impulse Response) type digital filters 51LA to 51LF respectively and to an addition circuit 52R by way of FIR-type digital filters 51RA to 51RF respectively. The transfer functions of the FIR-type digital filters 51LA to 51LF and the FIR-type digital filters 51RA to 51RF are set at predefined values. Impulse responses obtained as a result of transformation of the head related transfer functions HL and HR into time-axis functions are convoluted on the audio signals SSA to SSF.

It should be noted that the head related transfer functions HL and HR can be found by generating an acoustic impulse from a speaker at the position of the sound source 32 shown in FIG. 2 and measuring the acoustic impulse by using microphones at the positions of the ears of a dummy head placed at the location of the listener/watcher 30 also shown in FIG. 2. In this case, by using a TSP (Time Stretched Pulse) or the like in place of the acoustic impulse, the S/N (Signal to Noise) ratio can be improved.

Thus, the addition circuits 52L and 52R generate respectively audio signals SL and SR capable of reproducing a playback sound field, which is reproduced by the speakers 32A to 32F from the audio signals SSA to SSF, by means of the headphones.

The digital audio signals SL and SR are then supplied to D/A-conversion circuits 53L and 53R respectively to be converted into analog audio signals SL and SR respectively by D/A conversion. The analog audio signals SL and SR are supplied to respectively left and right acoustic units 55L and 55R of the headphones 55 by way of drive amplifiers 54L and 54R respectively. The left and right acoustic units 55L and 55R are each an electro-acoustic transducer.

Thus, the headphones 55 generates sounds represented by the audio signals SSA to SSF. At that time, the headphones 55 is capable of generating a reproduction sound field equivalent to a sound field obtained as a result of reproduction of the audio signals SSA to SSF by using the speakers 32A to 32F respectively. The sound images represented by the audio signals SSA to SSF are localized outside the head of the listener/watcher 30.

By doing this, however, the localized positions of the sound images generated by the headphones 55 are fixed in relation to the listener/watcher 30. Thus, when the listener/watcher 30 moves the head thereof, the sound images also move along the head as well.

In order to solve the above problem, the transfer functions provided by the filters 51LA to 51LF and 51RA to 51RF are made variable. In addition, as a means for detecting the orientation of the head of the listener/watcher 30, a rotational-angle sensor 56 is provided on the headphones 55. The rotational-angle sensor 56 is typically implemented by a piezoelectric vibratory gyroscope or an earth's magnetic field direction sensor. A signal output by the rotational-angle sensor 56 is supplied to a detection circuit 57. A detection signal output by the detection circuit 57 represents an angle at which the head of the listener/watcher 30 is rotated. The analog detection signal is supplied to an A/D (Analog to Digital) converter 58 for converting the detection signal into a digital detection signal in an A/D conversion process. The digital detection signal is supplied to a microcomputer 59 for further converting the digital detection signal into predetermined control signals SSCTL and SVCTL. It should be noted that, a sensor for detecting a rotational-angular speed is used for detecting a rotational angular speed in place of the rotational-angle sensor 56 for detecting a rotational angle, the detection circuit 57 is provided with an integration circuit for converting the rotational angular speed into a rotational angle.

The control signal SSCTL is supplied to the filters 51LA to 51LF and 51RA to 51RF as a control signal of the transfer functions. In the case of a sound image localized right in front of the listener/watcher 30, for example, when the orientation of the head of the listener/watcher 30 is changed in the clockwise direction by an angle of 90 degrees, the transfer functions of the filters 51LA to 51LF and 51RA to 51RF are controlled so that the sound image moves in the counterclockwise direction by an angle of 90 degrees. Thus, from the standpoint of the listener/watcher 30, the sound image appears to be fixed at its original position in the external field. That is to say, when the orientation of the head of the listener/watcher 30 is changed by an angle, the transfer functions of the filters 51LA to 51LF and 51RA to 51RF are controlled so that the localized position of the sound image is moved in the direction opposite to the movement of the orientation by an equal angle. As a result, the sound image appears to be fixed at its original position in the external field.

On the other hand, the control signal SVCTL is supplied to the cut-out circuit 42 as a signal for controlling the extraction of the video signal SV. When the orientation of the head of the listener/watcher 30 is changed from the north to the east, for example, the extraction range of the cut-out circuit 42 is controlled so that the range of the cut-out circuit 42 to extract the video signal SV from wide-angle images is changed from a north orientation to an east orientation. Thus, from the standpoint of the listener/watcher 30, the sound appears to be fixed at its original position in the external field. That is to say, when the orientation of the head of the listener/watcher 30 is changed by an angle, the range of the cut-out circuit 42 to extract the video signal SV from wide-angle images is changed in the same direction as the movement of the orientation by an equal angle.

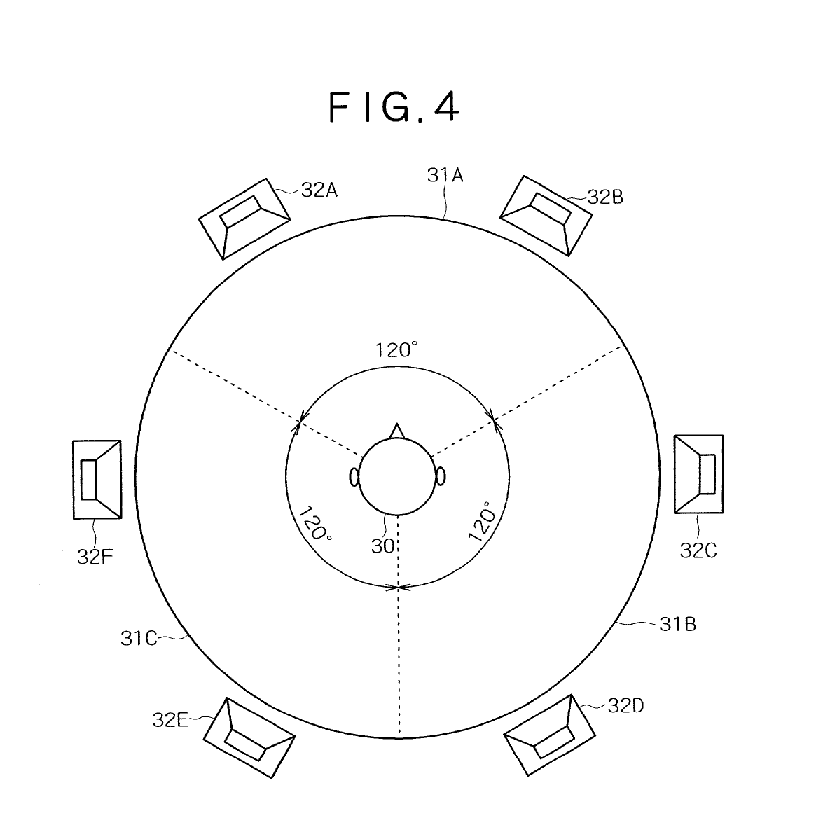

As described above, in accordance with the reproduction apparatus 40 described above, the HMD 45 and the headphones 55 are capable of reproducing a wide-angle image and a wide-angle sound respectively. Thus, a large-size reproduction apparatus like the one shown in FIG. 4 is not required. As a result, a wide-angle image and a wide-angle sound can be enjoyed even at an ordinary home.

In addition, when the listener/watcher 30 changes the orientation of the head, the range of an image and the localized position of a sound image are also varied accordingly. Thus, when the listener/watcher 30 changes the orientation of the head, viewed from the listener/watcher 30, an image and a sound image will no longer appear to move together. As a result, it is possible to reproduce an image and a sound that are equivalent to those reproduced by the reproduction apparatus shown in FIG. 4.

In the example described above, audio signals are reproduced by the headphones 55 mounted on the head of the listener/watcher 30. However, the audio signals can also be reproduced by a pair of speakers placed at the positions close to both ears of the listener/watcher 30 without directly mounting the headphones 55 on the head. In this case, nevertheless, when the listener/watcher 30 changes the orientation of the head, transfer functions between the ears of the listener/watcher 30 and the speakers also changes as well. Correction processing is thus required.

In addition, in the example described above, a video signal of an image and an audio signal of a sound are supplied wherein the image and the sound are stretched over a range covering the 360-degree surroundings of the listener/watcher 30. It is not necessary, however, to supply a video signal representing all prepared surroundings of the listener/watcher 30. Instead, it is necessary to merely supply a video signal of an image over a range broader than at least a visual-field range in which the listener/watcher 30 can watch the image through an HMD. Then, in the case of a real image taken by a video camera, a necessary portion is cut out from the image in accordance with the visual-field range of the listener/watcher 30 as is the case with the example described above. In the case of a synthesized image such as a CG, on the other hand, it is necessary to prepare a video-synthesizing circuit for synthesizing video signals sequentially in accordance with the visual-field range of the listener/watcher 30.

It should be noted that, while the video signals SVA to SVC and the audio signals SSA to SSF are presented to the listener/watcher 30 by using the DVD 25 in accordance with what is described above, it is also possible to present the signals by using other media such as a wire or radio network in a real-time manner.

The number of video cameras and the number of microphones can be changed so as to allow images and sounds from all directions to be recorded. For example, a half-spherical mirror is provided in an upward or downward orientation as is the case with an operation to take a picture of the whole sky, and an image reflected by the half-spherical mirror is photographed by using a video camera. In this case, one video camera is enough. Even if a fisheye lens is used as an alternative, only one video camera is required. Microphones can be laid out to allow sounds generated by sound sources to be recorded individually or, in place of the microphones, a signal generated by an electronic musical instruments or a sound-source synthesizer may also be recorded to be reproduced later.

In accordance with the present invention, an HMD (Head Mounted Display) and headphones are used for reproducing an image and a sound respectively as if the image and the sound were originated from all directions. Thus, a large-size reproduction apparatus like the one shown in FIG. 4 is not required. As a result, a wide-angle image and a wide-angle sound can be enjoyed even at an ordinary home with ease.

In addition, when the listener/watcher 30 changes the orientation of the head, the range of an image and the localized position of a sound image are also varied accordingly. Thus, when the listener/watcher 30 changes the orientation of the head, viewed from the listener/watcher 30, an image and a sound image will no longer appear to move together. As a result, it is possible to reproduce an image and a sound that are equivalent to those reproduced by the reproduction apparatus shown in FIG. 4.

While a preferred embodiment of the invention has been described using specific terms, such description is for illustrative purposes only, and it is to be understood that changes and variations may be made without departing from the spirit or scope of the following claims.

What is claimed is:

1. An audio and video reproduction apparatus comprising:
a head mounted display for converting a video signal into an image to present to a listener/watcher;
a pair of acoustic transducers each used for converting an audio signal into a sound to present to said listener/watcher;
detection means for detecting an orientation of the head of said listener/watcher;
image-changing means for changing said video signal supplied to said head mounted display in accordance with an orientation of the head of the listener/watcher; and
sound-image localization processing means for changing an sound-image localized position of an audio signal reproduced by said acoustic transducers, in accordance with an orientation of the head of said listener/watcher.

2. An audio and video reproduction apparatus according to claim 1 wherein said pair of the acoustic transducers are headphones mounted on the head of said listener/watcher or a pair of earphones attached to the ears of said listener/watcher.

3. An audio and video reproduction apparatus according to claim 1 wherein said pair of the acoustic transducers are speakers provided at positions close to the ears of said listener/watcher.

4. An audio and video reproduction apparatus according to claim 1 wherein said detection means comprises a sensor mounted on the head of said listener/watcher and a conversion unit for converting a detection signal generated by said sensor into a signal representing the orientation of the head of said listener/watcher.

5. An audio and video reproduction apparatus according to claim 1 wherein said image-changing means is a cut-out circuit for extracting a video signal representing an image stretched over a visual-field range visible to said listener/watcher by means of said head mounted display from a video signal representing an image stretched over a range wider than said visual-field range in accordance with an orientation of the head of said listener/watcher.

6. An audio and video reproduction apparatus according to claim 1 wherein said image-changing means is a cut-out circuit for extracting a video signal representing an image stretched over a visual-field range of said listener/watcher from a video signal representing an image stretched over a 360-degree range surrounding said listener/watcher in accordance with an orientation of the head of said listener/watcher.

7. An audio and video reproduction apparatus according to claim 1 wherein said image-changing means is a video synthesis circuit for synthesizing video signals representing images stretched over a visual-field range visible to said listener/watcher by means of said head mounted display in accordance with an orientation of the head of said listener/watcher.

8. An audio and video reproduction apparatus according to claim 1 wherein said sound-image localization processing means carries out sound-image localization processing based on transfer functions from a sound-image localized position of said audio signal to the ears of said listener/watcher to produce said audio signal, which is supplied to said pair of the acoustic transducers as if said audio signal were localized at said sound image localized position.

9. An audio and video reproduction apparatus according to claim 1 wherein said sound-image localization processing means converts an audio signal representing a sound covering a 360-degree range surrounding said listener/watcher into an audio signal, which is supplied to said pair of the acoustic transducers as a reproduction signal as if said reproduced sound image were localized outside the head of the listener/watcher.

10. An audio and video reproduction apparatus according to claim 1 wherein said video signal supplied to said head mounted display and said audio signals supplied to said acoustic transducers are reproduced from a recording medium.

11. An audio and video reproduction apparatus according to claim 1 wherein said video signal supplied to said head mounted display and said audio signals supplied to said acoustic transducers are received from a network in a real-time manner.
